(19) United States
(12) Patent Application Publication
(10) Pub. No.: US 2007/0177642 A1
(43) Pub. Date: Aug. 2, 2007

(54) Achieving ultra-short pulse in mode locked fiber lasers by flattening gain shape

(75) Inventor: Jian Liu, Sunnyvale, CA (US)

Correspondence Address: Bo-In Lin, 13445 Mandoli Drive, Los Altos Hills, CA, 94022, US

(73) Assignee: PolarOnyx, Inc.

(21) Appl. No.: 11/583,490

(22) Filed: Oct. 17, 2006

Related U.S. Application Data
(60) Provisional application No. 60/727,306, filed on Oct. 17, 2005.

(51) Int. Cl. H01S 3/13

(52) U.S. Cl. 372/30

(57) ABSTRACT

A fiber laser cavity that includes a fiber laser cavity that includes a laser gain medium for receiving an optical input projection from a laser pump. The fiber laser cavity further includes a positive dispersion fiber segment and a negative dispersion fiber segment for generating a net negative dispersion for balancing a self-phase modulation (SPM) and a dispersion induced pulse broadening-compression in the fiber laser cavity for generating an output laser with a transform-limited pulse shape wherein the laser gain medium further amplifying and compacting a laser pulse. The fiber laser cavity further includes a gain-flattening filter for flattening a gain over a range of wavelengths whereby the laser cavity is enabled to amplify a laser with improved pulse shape over the range of wavelengths.

This Formal Application claims a Priority Date of Oct. 17, 2005 benefit from a Provisional Patent Application 60/727,306 and Oct. 17, 2005 filed by a common Co-inventors of this Application.

### FIELD OF THE INVENTION

The present invention relates generally to apparatuses and methods for providing short-pulsed mode-locked fiber laser. More particularly, this invention relates to new configurations and methods for providing a nonlinear polarization pulse-shaping mode-locked fiber laser with improved and better controllable pulse shapes.

### BACKGROUND OF THE INVENTION

Conventional technologies of generating short pulse mode-locked fiber laser are still confronted with technical difficulties and limitations that the practical applications of the ultra-short pulse and high power laser cannot be easily achieved. Specifically, the practical usefulness of the ultra-short high power lasers are often hindered by the pulse shapes distortions. Particularly, a gain narrowing effect is often happens when a gain medium is used to amplify a laser pulse. The pulse narrowing effects further are wavelength dependent and have an uneven amplification characteristic as that shown in FIG. 1. For a short pulse with wide spectrum, it tends to narrow the spectrum after passing through the gain medium for amplification and the wavelength dependent pulse shape distortion limits the pulse width of the amplified laser output. In addition to the problems related to pulse shape distortions, the laser systems for generating a short pulse width laser output are often bulky, difficult for alignment maintenance, and also lack sufficient robustness. All these difficulties prevent practical applications of the ultra-short high power lasers.

Historically, generation of mode-locked laser with the pulse width down to a femtosecond level is a difficult task due to limited resources of saturation absorbers and anomalous dispersions of fibers. Conventionally, short pulse mode locked fiber lasers operated at wavelengths below 1.3 μm present a particular challenge is that there is no simple all fiber based solution for dispersion compensation in this wavelength regime. (For wavelengths above 1.3 μm, several types of fibers exist exhibiting either normal or anomalous dispersion, so by splicing different lengths of fibers together one can obtain a cavity with an adjustable dispersion.) Therefore, previous researchers use bulk devices, such as grating pairs and prisms to provide an adjustable amount of dispersion for the cavity. Unfortunately these devices require the coupling of the fiber into a bulk device, which results in a laser that is highly sensitive to alignment and thus the environment

Several conventional techniques disclosed different semiconductor saturation absorbers to configure the ultra-short high power laser systems. However, such configurations often developed into bulky and less robust systems due to the implementations of free space optics. Such systems have been disclosed by S. N. Bagayev, S. V. Chepurov, V. M. Klementyev, S. A. Kuznetsov, V. S. Pivtsov, V. V. Pokasov, V. F. Zakharyash, A femtosecond self-mode-locked Ti:sapphire laser with high stability of pulserepetition frequency and its applications (Appl. Phys. B, 70, 375-378 (2000).), and Jones D. J., Diddams S. A., Ranka J. K., Stentz A., Windeler R. S., Hall J. L., Cundi® S. T., Carrierenvelope phase control of femtosecond mode-locked laser and direct optical frequency synthesis. (Science, vol. 288, pp. 635-639, 2000.). 70, 375-378 (2000).).

Subsequently, the stretched mode-locked fiber lasers are disclosed to further improve the generation of the short pulse high power lasers. However, even in the stretched mode locked fiber lasers, the free space optic components such as quarter wave retarder and splitters for collimating and coupling are implemented. Examples of these systems are described by John L. Hall, Jun Ye, Scott A. Diddams, Long-Sheng Ma, Steven T. Cundi®, and David J. Jones, in “Ultrasensitive Spectroscopy, the Ultrastable Lasers, the Ultrafast Lasers, and the Seriously Nonlinear Fiber: A New Alliance for Physics and Metrology” (IEEE JOURNAL OF QUANTUM ELECTRONICS, VOL. 37, NO. 12, DECEMBER 2001), and also by L. Hollberg, C. W. Oates, E. A. Curtis, E. N. Ivanov, S. A. Diddams, Th. Udem, H. G. Robinson, J. C. Bergquist, R. J. Rafac, W. M. Itano, R. E. Drullinger, and D. J. Wineland, in “Optical frequency standards and measurements” IEEE J. Quant. Electon. 37, 1502 (2001).

The limitations for practical application of such laser systems are even more pronounced due the pulse shape distortions when the pulse width is further reduced compounded with the requirement of high power fiber amplification. When the pulse width narrows down to femtosecond level and the peak power increases to over 10 kW, strong nonlinear effects such as self phase modulation (SPM) and XPM will cause more serious spectral and temporal broadening. These nonlinear effects and spectral and temporal broadening further causes a greater degree of distortions to the laser pulses. The technical difficulties cannot be easily resolved even though a large mode area (LMA) fiber can be used to reduce SBS and SRS to increase saturation power. However, the large mode area fiber when implemented will in turn cause a suppression of the peak power and leads to an undesirable results due to the reduction of the efficiency

There is an urgent demand to resolve these technical difficulties as the broader applications and usefulness of the short pulse mode-locked are demonstrated for measurement of ultra-fast phenomena, micro machining, and biomedical applications. Different techniques are disclosed in attempt to resolve such difficulties. Such techniques include the applications of nonlinear polarization rotation (NLPR) or stretched mode locked fiber lasers as discussed above. As the NLPR deals with the time domain intensity dependent polarization rotation, the pulse shape distortions cannot be prevented due to the polarization evolution in both the time domain and the spectral domain. For these reasons, the conventional technologies do not provide an effective system configuration and method to provide effective ultra-short pulse high power laser systems for generating high power laser pulses with acceptable pulse shapes.

In addition to the above described difficulties, these laser systems require grating pairs for dispersion control in the laser cavity. Maintenance of alignment in such systems becomes a time consuming task thus prohibiting a system implemented with free space optics and grating pairs from practical applications. In addition to these difficulties, the grating pairs further add to the size and weight of the laser devices and hinder the effort to miniaturize the devices implemented with such laser sources.

Therefore, a need still exists in the art of fiber laser design and manufacture to provide a new and improved configuration and method to provide ultra-short high power mode-locked fiber laser with better controllable pulse shapes such that the above discussed difficulty may be resolved.

### SUMMARY OF THE PRESENT INVENTION

It is therefore an object of the present invention to provide a method of using nonlinear polarization evolution (NPE) and dispersion managed fiber cavity to manipulate the pulse propagation in the cavity and balance the self phase modulation (SPM) and dispersion induced pulse broadening/compressing. This method of polarization pulse shaping generates transform-limited pulse shapes through combinational effects of fiber length, the non-linear effects and dispersion and further aided with a gain-flattening effect of a gain-flattening filter such that the above-described difficulties encountered in the prior art can be resolved.

Specifically, a gain-flattening filter is added to the laser system before or after the gain medium to overcome the uneven pulse width narrowing and wavelength dependent gain distortion effects. The gain-flattening filter provides a flatten gain over the amplified wavelength before or after the laser is amplified thus improves the pulse shape and enable the achievement of a shorter pulse width without being limited by the pulse width narrowing and wavelength dependent gain distortions as that occurs in the conventional laser systems.

Briefly, in a preferred embodiment, the present invention discloses a fiber laser cavity that includes a fiber laser cavity that includes a laser gain medium for receiving an optical input projection from a laser pump. The fiber laser cavity further includes a positive dispersion fiber segment and a negative dispersion fiber segment for generating a net negative dispersion for balancing a self-phase modulation (SPM) and a dispersion induced pulse broadening-compression in the fiber laser cavity for generating an output laser with a transform-limited pulse shape wherein the laser gain medium further amplifying and compacting a laser pulse. The fiber laser cavity further includes a gain-flattening filter for flattening a gain over a range of wavelengths whereby the laser cavity is enabled to amplify a laser with improved pulse shape over the range of wavelengths. In a preferred embodiment, the fiber laser cavity further includes a beam splitter functioning as a polarization sensitive isolator for transmitting a portion of a laser pulse to a pair of gratings for transmitting a light projection with an anomalous dispersion for further shaping the output laser. In another preferred embodiment, the fiber laser cavity further includes a Faraday rotating mirror for reversing a polarization of a laser from the pair of gratings. In a preferred embodiment, the gain medium further includes a Ytterbium doped fiber for amplifying and compacting a laser pulse. In another preferred embodiment, the fiber laser cavity further includes a polarization sensitive isolator and a polarization controller for further shaping the output laser.

In a preferred embodiment, this invention further discloses a method for method for generating a pulse-shaped transform-limited output laser from a laser cavity that includes a laser gain medium. The method includes a step of forming the laser cavity by employing a positive dispersion fiber segment and a negative dispersion fiber segment for generating a net negative dispersion. The method further includes a step of projecting an input laser from a laser pump into the fiber laser cavity for amplifying and compacting a laser pulse in the gain medium to balance a dispersion induced nonlinearity with a self-phase modulation (SPM) in the fiber laser cavity for generating an output laser with a transform-limited pulse shape. And, the method further includes a step of flattening a gain over a range of wavelengths by implementing a gain-flattening filter whereby the laser cavity is enabled to amplify a laser with improved pulse shape over the range of the wavelengths. In a preferred embodiment, the step of implementing a gain-flattening filter further includes a step of disposing the gain-flattening filter before the gain medium. In another preferred embodiment, the step of implementing a gain-flattening filter further includes a step of disposing the gain-flattening filter after the gain medium. In another preferred embodiment, the step of implementing a gain-flattening filter further includes a step of disposing the gain-flattening filter inside the gain medium. In another preferred embodiment, the step of implementing a gain-flattening filter further includes a step of implementing the gain-flattening filter as a thin-film gain-flattening filter. In another preferred embodiment, the step of implementing a gain-flattening filter further includes a step of implementing the gain-flattening filter as a fiber-grating gain-flattening filter. In another preferred embodiment, the step of implementing a gain-flattening filter further includes a step of implementing the gain-flattening filter as a multiple-stage gain-flattening filter.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 shows waveform diagrams to illustrate the gain narrowing effect and wavelength dependent distortion usually occurs in a laser system implemented with a gain medium fiber.

FIG. 2 is functional block diagram for an all fiber short-pulse mode-locked fiber laser that includes a gain-flattening filter of this invention.

FIG. 3 shows waveform diagrams to illustrate the improvement achieved by the gain flattening filter to resolve the problems of the gain narrowing effect and wavelength dependent distortion.

FIG. 4 shows a gain-flattening filter implemented as fiber gratings in a gain medium for achieving broader gain flatness.

FIG. 5 is a schematic functional block diagram for showing a high power laser amplifier for generating femtosecond pulses.

### DETAILED DESCRIPTION OF THE INVENTION

Referring to FIG. 2 for a schematic diagram of a nonlinear polarization pulse-shaping mode locked fiber laser 100 of this invention. The fiber system is an ultra compact and low cost all-fiber based high power femtosecond fiber laser system of this invention. This is a laser system formed with all fiber-based components. The fiber laser has a ring configuration receiving a laser input through a 980 or 1060 nm WDM 110. In an exemplary embodiment, a 980 nm high power pump laser diode 101 was used to pump the gain fibers 105 for amplifying the pulses circulating in the cavity. The all fiber-based laser 100 included a gain medium 105 to amplify and compress the pulse width of a laser projection in the laser cavity. The gain medium 110 can be an Yb doped fiber (YDF), an erbium doped fiber (EDF) or a Tm doped fiber (TDF) for wavelength of 1 μm, 1.55 μm or 2 μm respectively. The gain medium 110 has high doping concentration. For an exemplary gain medium 105 of YDF, the gain medium fiber 105 may have a high doping concentration of 600 dB/m at 976 nm, with a dispersion of −55 ps/nm/km. The laser cavity 100 further includes a regular transmission fiber 115 that may include a single mode (SM) fiber, e.g., a −20 ps/nm/km fiber 115. The laser cavity further includes a special second fiber 125 for dispersion matching. For wavelength of 1 um, the second fiber may be a photonic crystal fiber PCF or photonic band-gap fiber PBF in providing anomalous dispersion. For a wavelength at approximately 1.55 um, a second fiber 125 is implemented with piece of SM 28 for anomalous dispersion and high NA fiber for normal dispersion. For a wavelength near 2 um, similar second fiber may be uses as that implemented for a wavelength of about 1.55 um.

The all fiber-based laser 100 employs an in-line polarization controller 140-1 and 140-2 before and after an in-line polarization sensitive isolator 135 that is implemented with single mode (SM) fiber pigtails. The in-line polarization sensitive control may be a product commercially provided by General Photonics, e.g., one of PolaRite family products. The polarizing isolator 135 has a high extinction ratio and only allows one linear polarization pass through over a wide spectrum. Due to nonlinear effects of SPM, the index of refraction will be dependent on the power intensity so that, in each individual pulse, high intensity peak will experience different intensity-induced birefringence with what low intensity wings will experience. When aligning the peak polarization with the polarizing isolator, only peak portion of the pulse can be transmitted and the wings portion will be blocked. Therefore, the pulse can be mode locked to femtosecond level by combining the polarization shaping and dispersion management. A polarization splitter is used as a coupler 130 to couple partial of the light as output of the cavity at a given polarization state. The whole cavity average dispersion is designed to operate at anomalous dispersion (β″<0). The second fiber 125, e.g., a PC fiber 125, can provide both normal and anomalous dispersion at 1060 nm range with its uniquely structured properties and can also manipulate their dispersion slope, a fiber laser cavity can be designed with both dispersion and dispersion slope matched so the pulse can be narrowed to the maximum. In contrast to the prior art technologies, the system as shown in FIG. 2 considers polarization evolution in both time domain (intensity dependent) and spectral domain (wavelength dependent) in achieving ultra-short pulse <50 fs. The polarization filtering is achieved by managing both dispersion and dispersion slope and further by using fiber-based inline polarizing isolator and polarization controllers.

Different from other approaches in achieving short pulse mode locked fiber lasers, a special all fiber cavity is disclosed in FIG. 2 to manage the pulse propagation in the cavity and balance the SPM and dispersion to reduce the saturation effects in the amplification region. As disclosed in two previously co-pending patent application Ser. Nos. 11/093,519 and 11/136,040 filed by a common inventor of this Application, the cavity laser achieves short pulse mode locked fiber lasers at one micron region by implementing a totally different configuration. The disclosures made in these Applications are hereby incorporated by reference. A sigma configuration is disclosed that provides the advantages of managing the pulse propagation in the cavity and in the meantime balance the self-phase modulation (SPM) and dispersion to reduce the saturation effects in the amplification region. On the other hand, NPE induced by the nonlinear phase change of SPM will make the polarizations within single pulse intensity dependent. When the pulse is transmitted through the polarization sensitive splitter, only the highest intensity lined up with the splitter (by adjusting the polarization controllers) is passed and the lower intensity part of the pulse will be filtered and the pulse therefore be shaped. This works as a saturation absorber (SA) and reduce the pulse width.

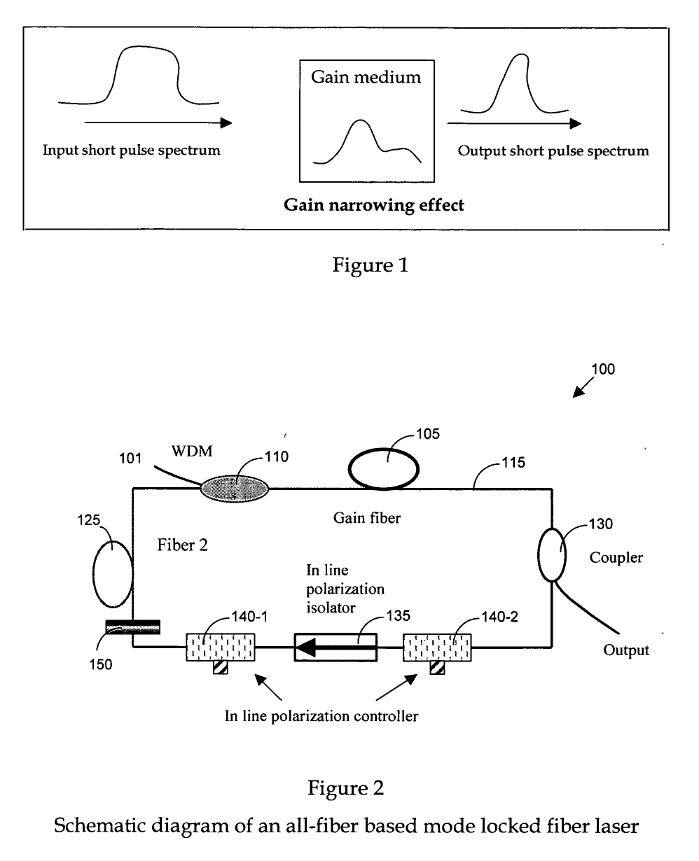

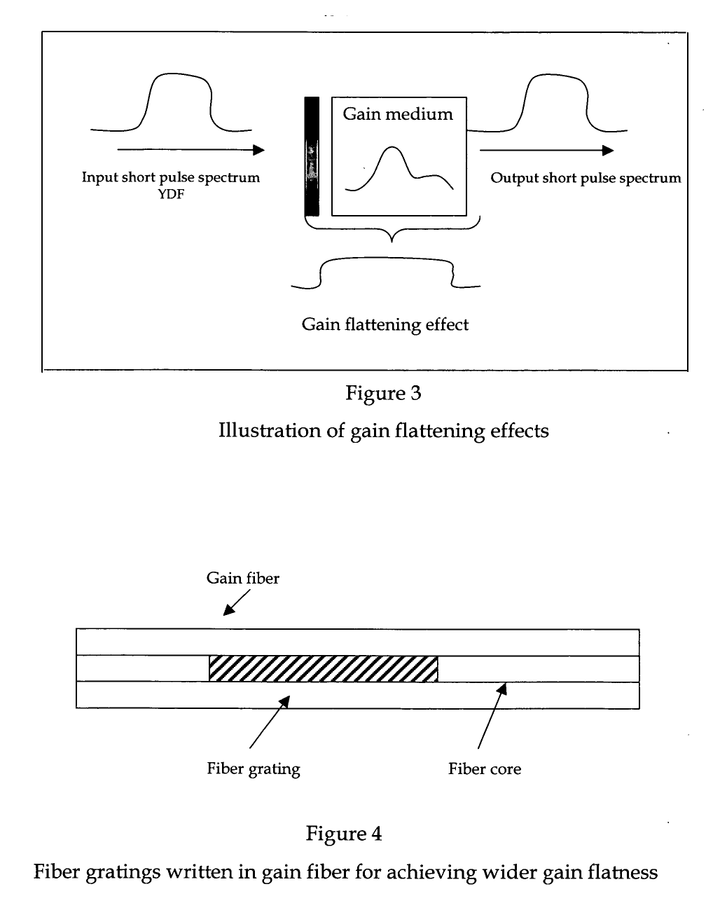

Referring to FIG. 2 again, the all fiber laser system 100 further includes a gain flattening filter 150 to flatten the gain shape thus enables the system to further reduce the pulse width by using wider gain bandwidth in the spectral domain. FIG. 3 shows the effects of the gain-flattening filter that flattens the gain thus enables short pulse width because the band narrowing effect of the gain medium is now resolved and output pulse has improved pulse shape when compared to the pulse shaped shown in FIG. 1. By using a gain-flattening filter, the filter is designed to have a special shape to compensate the uneven gain shape intrinsic to the gain medium. The combination of the filter and gain medium will provide an equivalent flat gain shape. As shown in FIG. 3, a pulse is amplified, the amplified pulse will remain its original spectrum without any narrowing effects. The gain-flattening filter 150 can be flexibly placed before/after the gain medium 105 or can also be put in the gain medium. The gain-flattening filter 150 can be thin film type of filter or can be implemented as fiber gratings as will be further described below.

The gain-flattening filter 150 as shown in FIG. 2 may be employed not only in all mode locked seed lasers as shown, but also in other all multiple stage laser systems. The application of the gain-flattening filter is not limited to fiber lasers but also in all other types of laser systems such as solid state lasers, for the purpose of providing an ultra-short fiber with reduced pulse width and higher energy output.

In an exemplary embodiment, the amplification is achieved by using a short piece of high concentration double cladding Yd-doped fiber (DCYDF) with large mode area (LMA) 105. The LMA 105 of the DCYDF combined with short length help balance the nonlinear effects such as SPM and XPM with the dispersion so the pulse width will not be broadened after amplification. This DCYDF can be a PC fiber as well in balancing the dispersion and SPM. The laser system as shown in FIG. 2 has the advantages that it is alignment and maintenance free. It is much easier to handle the all-fiber based fiber laser and amplifiers than conventional mode locked solid state and/or fiber lasers. There are no alignment and realignment issues related. After the fibers and components are spliced together and packaged, there will be no need of specially trained technician for operation and maintenance, which reduce the cost and risk significantly in the field applications. Furthermore, it can be easily integrated with other module, such as telescope/focusing system without extra optical alignment effort due to the flexibility of optical fiber. The laser system further takes advantage of the fully spectrum of the gain of the YDF and provides a high quality laser that is suitable for processing the nano-material. The laser system is implemented with all photonic crystal fibers for both the gain medium and transmission fibers in the cavity to compensate both the dispersions and dispersion slope. The photonic crystal (PC) fiber shows novel properties in manipulating its structures such as hollow lattice shapes and filling factors to obtain both normal and anomalous dispersion below 1300 nm range. The PC fiber is used to compensate both dispersions and slope in the cavity and make short pulsed fiber laser by selecting various PC fibers. Further more, due to one of its unique features of smaller effective area than the regular single mode fibers, stronger nonlinear effects can be caused in the fiber and its impact on SPM can be utilized to achieve shorter cavity by selecting an appropriate PC fiber. On the other hand, by using the feature of air core PC fiber, larger pulse energy can be extracted.

Referring to FIG. 3 for another exemplary embodiment of this invention where the gain flattening filter 150′ is implemented as fiber gratings in the fiber core of a gain medium fiber 105′. The gain flattening filter 150′ when implemented as part of the gain medium fiber 105 can achieve simplified configuration and even more impact laser systems.

The polarization shaping mode locked techniques as disclosed in this invention by managing the pulse propagation in the cavity and balance the SPM and dispersion to reduce the saturation effects in the amplification region are different from conventional approach such as Nonlinear Polarization Rotation (NLPR) or stretched mode approach as that disclosed by John L. Hall, et al, L. Hollberg et et al., and S. A. Didamms et al., as discussed above. There are at least three major differences:
1) The conventional NLPR technologies only consider time domain intensity dependent polarization rotation. The present invention applies the polarization evolution of the optical transmissions take into account the variations in both the time domain (intensity dependent) and the spectral domain (wavelength dependent). This is accomplished by selecting a polarizer and quarter wave plate and half wave plate (QWR/HWR). Basically the bandwidth of the retarders is proportional to the index difference Δn of the birefringence material, Phase=NΔn/λ, λ is the wavelength, N is the order of the retarder or birefringence material such as fiber, In differentiating the equation, it will find out that the bandwidth Δλ is inversely proportional to the production of NΔn. This indicates that the laser system of this invention can achieve a larger bandwidth operation by using a low order of retarder, e.g., N=1, and a low birefringence material. Therefore, the retarders are adjusted to let a larger bandwidth pass through the polarizer or a polarization sensitive isolator.
2) The conventional technologies consider only dispersion match, while the pulse shaping functions of this invention takes into account not only the dispersion match but also dispersion slope match to assure the dispersion match is managed over a larger spectral bandwidth. This can be done by using a combination of two or more fiber s with different dispersion and slopes, for example, fiber 1 have different dispersion and dispersion slopes, by combining them together at a proper length ratio, the total dispersion will be able to reach zero at the interested wavelength region over a large range as shown in the FIG. 1A. Therefore, the present invention provides a laser system that is enabled to utilize the gain-bandwidth to the maximum and push the pulse width to the minimum accordingly since the bandwidth is inversely proportional to the pulse width.
3) The conventional laser systems are implemented with bulk free space optic in their laser system for either dispersion compensation or polarization control. As that shown in FIG. 1 and will be further described below, this invention is implemented with the all fiber based components and eliminate all free space components. The systems as disclosed in this invention thus provide the ultimate way in making compact and ultra-short pulse laser module for nano-processing system applications.

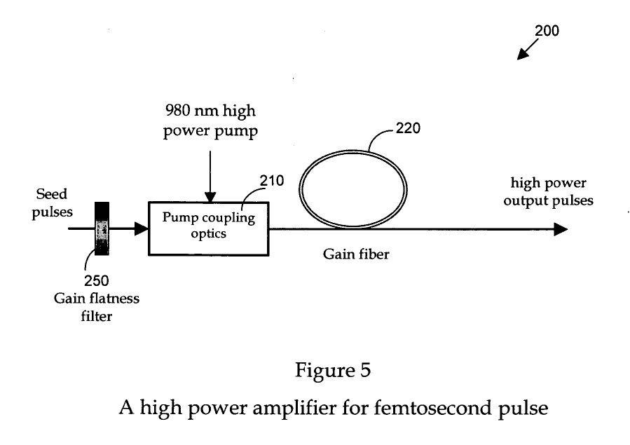

Referring to FIG. 5 wherein a gain flattening filter 250 is implemented in a high power amplifier 200 for generating laser pulses with femtosecond pulse-width. The high power amplifier 200 includes a pump coupling optics 210 to couple to a high power pump to receive input laser transmissions. The high power amplifier 200 further includes a gain fiber 220 to amplify the input laser into a high power output laser. Similarly, the gain flattening filter 250 can be implemented as part of the gain fiber 220. Alternately, the gain flattening filter 250 can be flexibly placed before or after the gain fiber.

As shown in FIG. 5, a high power amplifier 220 is used to boot the seed pulse inputted from a high power pump through a pump coupling optics 210 to an average power up to 10 W with femetosecond ultra-short pulse amplification. This is different from the CW (continuous wave) and nano-second (NS) pulse. Special consideration must be taken into accounts of the effects of SPM, XPM, and FWM. The dispersion has to be carefully selected to make all effects matched and balanced to avoid any pulse broadening and distortion in the non-linear short pulse fiber transmission modes. The gain-flattening filter 250 further improves the output pulse shape of such high power amplifier.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A laser cavity comprising a laser gain medium for receiving an optical input projection from a laser pump, wherein said fiber laser cavity further comprising:
a positive dispersion fiber segment and a negative dispersion fiber segment for generating a net negative dispersion for balancing a self-phase modulation (SPM) and a dispersion induced pulse broadening/compression in said laser cavity for generating an output laser with a transform-limited pulse shape wherein said laser gain medium further amplifying and compacting a laser pulse; and
a gain-flattening filter for flattening a gain over a range of wavelengths whereby the laser cavity is enabled to amplify a laser with improved pulse shape over said range of wavelengths.

2. The laser cavity of claim 1 further comprising:
a polarization splitter, a polarization controller and a wavelength division multiplexing (WDM) coupler; and
said laser cavity further comprising an all fiber laser cavity with said polarization splitter, said polarization controller and said WDM configured with a fiber connectivity for connecting to said gain medium, said gain flattening filter through said positive dispersion fiber segment and said negative dispersion fiber segment.

3. The laser cavity of claim 1 wherein:
said positive dispersion fiber segment further comprising said gain medium of a Ytterbium doped fiber having a normal dispersion for amplifying and compacting a laser pulse; and
said negative dispersion fiber segment further comprising a photonic crystal fiber (PCF) for operating with a 1 μm laser.

4. The laser cavity of claim 1 wherein:
said positive dispersion fiber segment further comprising said gain medium of a Ytterbium doped fiber having a normal dispersion for amplifying and compacting a laser pulse; and
said negative dispersion fiber segment further comprising a photonic bandgap fiber (PBF) for operating with a 1 μm laser.

5. The laser cavity of claim 1 wherein:
said positive dispersion fiber segment further comprising said gain medium of an Erbium doped fiber (EDF) having a normal dispersion for amplifying and compacting a laser pulse; and
said negative dispersion fiber segment further comprising a regular transmission fiber for operating with a 1.55 μm laser.

6. The laser cavity of claim 1 wherein:
said positive dispersion fiber segment further comprising said gain medium of an Erbium doped fiber (EDF) having a normal dispersion for amplifying and compacting a laser pulse; and
said negative dispersion fiber segment further comprising a PCF for operating with a 1.55 μm laser.

7. The laser cavity of claim 1 wherein:
said positive dispersion fiber segment further comprising said gain medium of an Erbium doped fiber (EDF) having a normal dispersion for amplifying and compacting a laser pulse; and
said negative dispersion fiber segment further comprising a high NA fiber for operating with a 1.55 μm laser.

8. The laser cavity of claim 1 wherein:
said positive dispersion fiber segment further comprising said gain medium of an Tm doped fiber (TDF) having a normal dispersion for amplifying and compacting a laser pulse; and
said negative dispersion fiber segment further comprising a regular transmission fiber for operating with a 2 μm laser.

9. The laser cavity of claim 1 wherein:
said positive dispersion fiber segment further comprising said gain medium of an Tm doped fiber (TDF) having a normal dispersion for amplifying and compacting a laser pulse; and
said negative dispersion fiber segment further comprising a PCF for operating with a 2 μm laser.

10. The laser cavity of claim 1 wherein:
said positive dispersion fiber segment further comprising said gain medium of an Tm doped fiber (TDF) having a normal dispersion for amplifying and compacting a laser pulse; and
said negative dispersion fiber segment further comprising a high NA fiber for operating with a 2 μm laser.

11. The laser cavity of claim 1 further comprising:
a polarization sensitive isolator and a polarization controller for further shaping said output laser.

12. The laser cavity of claim 1 wherein:
said gain-flattening filter is disposed before said gain medium.

13. The laser cavity of claim 1 wherein:
said gain-flattening filter is disposed after said gain medium.

14. The laser cavity of claim 1 wherein:
said gain-flattening filter is disposed inside said gain medium.

15. The laser cavity of claim 1 wherein:
said gain-flattening filter further comprising a thin-film gain-flattening filter.

16. The laser cavity of claim 1 wherein:
said gain-flattening filter further comprising a fiber-grating gain-flattening filter.

17. The laser cavity of claim 1 wherein:
said gain-flattening filter further comprising a single-stage gain-flattening filter.

18. The laser cavity of claim 1 wherein:
said gain-flattening filter further comprising a multiple-stage gain-flattening filter.

19. The laser cavity of claim 1 further comprising:
a self-phase modulation induced NPE for generating a mode-lock laser in said laser cavity.

20. The laser cavity of claim 1 further comprising:
an isolator comprising a polarization sensitive splitter.

21. The laser cavity of claim 1 further comprising:
a polarization controller further comprising bulk optical quarter/half wave retarders.

22. The laser cavity of claim 1 further comprising:
an output adjustable coupler for adjusting a coupling ratio for obtaining different levels of an output laser.

23. The laser cavity of claim 1 further comprising:
an polarization controller for generating an output laser as a polarized or an un-polarized output laser.

24. The laser cavity of claim 1 further comprising:
a laser system constituting a self-start laser system.

25. The laser cavity of claim 1 wherein:
said laser cavity is a ring laser cavity.

26. The laser cavity of claim 1 wherein:
said gain medium comprising an Ytterbium doped fiber constituting a positive dispersion fiber segment with a dispersion about −55 ps/nm/km.

27. The laser cavity of claim 1 further comprising:
an output coupler for transmitting a portion of a laser as said output laser from said fiber laser cavity.

28. The laser cavity of claim 1 further comprising:
a single mode fiber constituting a fiber segment of a negative dispersion connected to said gain medium.

29. The laser cavity of claim 1 further comprising:
said gain medium further comprising a double cladding Ytterbium doped fiber (DCYDF).

30. The laser cavity of claim 1 further comprising:
said gain medium further comprising a double cladding Ytterbium doped fiber (DCYDF) with large mode area (LMA).

31. The laser cavity of claim 1 wherein:
said gain medium further comprising a double cladding Ytterbium doped photonic crystal fiber.

32. A method for generating a pulse-shaped transform-limited output laser from a laser cavity comprising a laser gain medium, the method comprising:
forming said laser cavity by employing a positive dispersion fiber segment and a negative dispersion fiber segment for generating a net negative dispersion;
projecting an input laser from a laser pump into said fiber laser cavity for amplifying and compacting a laser pulse in said gain medium to balance a dispersion induced nonlinearity with a self-phase modulation (SPM) in said fiber laser cavity for generating an output laser with a transform-limited pulse shape;
flattening a gain over a range of wavelengths by implementing a gain-flattening filter whereby the laser cavity is enabled to amplify a laser with improved pulse shape over the range of the wavelengths.

33. The method of claim 33 wherein:
said step of implementing a gain-flattening filter further comprising a step of disposing said gain-flattening filter before said gain medium.

34. The method of claim 33 wherein:
said step of implementing a gain-flattening filter further comprising a step of disposing said gain-flattening filter after said gain medium.

35. The method of claim 33 wherein:
said step of implementing a gain-flattening filter further comprising a step of disposing said gain-flattening filter inside said gain medium.

36. The method of claim 33 wherein:
said step of implementing a gain-flattening filter further comprising a step of implementing said gain-flattening filter as a thin-film gain-flattening filter.

37. The method of claim 33 wherein:
said step of implementing a gain-flattening filter further comprising a step of implementing said gain-flattening filter as a fiber-grating gain-flattening filter.

38. The method of claim 33 wherein:
said step of implementing a gain-flattening filter further comprising a step of implementing said gain-flattening filter as a multiple-stage gain-flattening filter.
